(19) United States
(12) Patent Application Publication
(10) Pub. No.: US 2026/0061310 A1
(43) Pub. Date: Mar. 5, 2026

(54) ONE OR MORE NON-TRANSITORY COMPUTER-READABLE MEDIA, INFORMATION PROCESSING METHOD, AND INFORMATION PROCESSING SYSTEM

(71) Applicant: NINTENDO CO., LTD., Kyoto (JP)

(72) Inventors: Masashi ONISHI, Kyoto (JP); Masahiro NAKAMURA, Kyoto (JP); Tatsuya OGAWA, Kyoto (JP)

(21) Appl. No.: 19/307,887

(22) Filed: Aug. 22, 2025

(30) Foreign Application Priority Data
Sep. 2, 2024 (JP) 2024-150749

(51) Int. Cl. A63F 13/42; A63F 13/798; A63F 13/803

(52) U.S. Cl. CPC A63F 13/42; A63F 13/798; A63F 13/803

(57) ABSTRACT

An example of a game system according to an exemplary embodiment executes a racing game where a player object is progressed on a course at least including a route from a first point to a second point. Based on determination two-dimensional data which is two-dimensional data corresponding to two-dimensional coordinate points with respect to a horizontal direction in a virtual space and in which a determination parameter indicating a degree of progress is recorded with respect to each coordinate point, the game system makes a first determination based on a value of the determination parameter at a coordinate point in the determination two-dimensional data corresponding to a position in the virtual space of the player object.

### CROSS REFERENCE TO RELATED APPLICATION

This application claims priority to Japanese Patent Application No. 2024-150749 filed on Sep. 2, 2024, the entire contents of which are incorporated herein by reference.

### FIELD

An exemplary embodiment relates to one or more non-transitory computer-readable media, an information processing method, and an information processing system for executing a racing game.

### BACKGROUND AND SUMMARY

Conventionally, there is a game where a racing game is performed on a course set in advance, and a ranking determination is made during the racing game.

For example, in a case where a race is performed in a wider range that deviates from a route, it may be difficult to make an appropriate ranking determination by a conventional method.

An exemplary embodiment discloses one or more non-transitory computer-readable media, an information processing method, and an information processing system that are capable of making a determination based on the degree of progress in a wider range in a racing game.

The exemplary embodiment employs the following configurations.

### First Configuration

A first configuration is one or more non-transitory computer-readable media having stored therein instructions that, when executed, cause one or more processors of an information processing apparatus to execute game processing. The game processing includes performing a racing game where a player object is progressed on a course set on a field in a virtual space and at least including a route from a first point to a second point on the field. The game processing includes, during the racing game, controlling the player object to move based on an operation input. The game processing includes, based on determination two-dimensional data which is two-dimensional data corresponding to two-dimensional coordinate points with respect to a horizontal direction in the virtual space in a predetermined range at least including the route and in which a first value is recorded for a coordinate point corresponding to the first point, a second value is recorded for a coordinate point corresponding to the second point, a determination parameter indicating a degree of progress from the first point to the second point with a value from the first value to the second value is recorded with respect to each coordinate point, making a first determination based on the value of the determination parameter at a coordinate point in the determination two-dimensional data corresponding to a position in the virtual space of the player object.

Based on the above, based on determination two-dimensional data, it is possible to make a determination regarding the degree of progress also in a place other than a route.

### Second Configuration

According to a second configuration, in the above first configuration, the racing game may be a racing game where the player object races another progress object. The game processing may further include: during the racing game, further controlling the other progress object to move; and as the first determination, determining a ranking of the player object regarding the degree of progress during the racing game based on the value of the determination parameter at the coordinate point in the determination two-dimensional data corresponding to the position in the virtual space of the player object and the value of the determination parameter at a coordinate point in the determination two-dimensional data corresponding to a position in the virtual space of the other progress object.

Based on the above, based on the determination two-dimensional data, it is possible to determine the provisional ranking of a player object during a racing game. For example, even if there is an object that progresses outside the route, it is possible to appropriately determine the ranking of the object.

### Third Configuration

According to a third configuration in the above first or second configuration, the first point may be a starting point of the course, and the second point may be a goal point of the course.

Based on the above, it is possible to make a determination regarding the degree of progress during a racing game of an object that progresses from a starting point to a goal point.

### Fourth Configuration

According to a fourth configuration, in the above first or second configuration, the first point may be a first checkpoint of the course, and the second point may be a second checkpoint set beyond the first checkpoint.

Based on the above, it is possible to make a determination regarding the degree of progress during a racing game of an object that progresses from a first checkpoint to a second checkpoint.

### Fifth Configuration

According to a fifth configuration, in the above second configuration, the game processing may further include, during the racing game, in accordance with contact between the player object and an item acquisition object on the field, causing the player object to acquire any of items set based on the ranking among a plurality of types of items.

Based on the above, in accordance with the ranking appropriately determined based on the determination two-dimensional data, it is possible to cause the player object to acquire an item.

### Sixth Configuration

According to a sixth configuration, in any of the above first to fifth configurations, the determination two-dimensional data may be data in which a value that changes from the first value to the second value along the route is set as the determination parameter at each of coordinate points corresponding to positions on the route, and data in which the determination parameter at each of coordinate points corresponding to positions other than the route is set so that the closer to the coordinate point corresponding to the second point the coordinate point is, the closer to the second value the value is.

Based on the above, also regarding a place other than the route, it is possible to make a determination based on the determination two-dimensional data in which an appropriate determination parameter is set.

### Seventh Configuration

According to a seventh configuration, in any of the above first to sixth configurations, the game processing may further include generating the determination two-dimensional data based on two-dimensional data in which the first value is set as the determination parameter at the coordinate point corresponding to the first point, and the second value is set as the determination parameter at the coordinate point corresponding to the second point, a value that changes from the first value to the second value along the route is set as the determination parameter at each of coordinate points corresponding to positions on the route, and a value based on the value of the determination parameter of a peripheral coordinate point for which the determination parameter is set is set for a coordinate point for which the determination parameter is not set.

Based on the above, it is possible to set determination parameters regarding positions on the route and other than the route.

### Eighth Configuration

An eighth configuration is one or more non-transitory computer-readable media having stored therein instructions that, when executed, cause one or more processors of an information processing apparatus to execute information processing. The information processing includes, based on a course that is used as a course of a racing game set on a field in a virtual space and at least includes a route from a first point to a second point on the field, generating determination two-dimensional data which is two-dimensional data corresponding to two-dimensional coordinate points with respect to a horizontal direction in the virtual space in a predetermined range at least including the route and in which as a determination parameter indicating a degree of progress from the first point to the second point is recorded with respect to each coordinate point, based on first two-dimensional data in which a first value is set as the determination parameter at a coordinate point corresponding to the first point, and a second value is set as the determination parameter at a coordinate point corresponding to the second point, a value that changes from the first value to the second value along the route is set as the determination parameter at each of coordinate points corresponding to positions on the route, and a value based on the value of the determination parameter of a peripheral coordinate point for which the determination parameter is set is set for a coordinate point for which the determination parameter is not set.

Based on the above, based on a course at least including a route from a first point to a second point, it is possible to generate determination two-dimensional data.

### Ninth Configuration

According to a ninth configuration, in the above eighth configuration, the information processing may further include generating the determination two-dimensional data so that coordinate points are set at predetermined distances in the virtual space based on the first two-dimensional data.

Based on the above, it is possible to generate determination two-dimensional data in which coordinate points are set at intervals of a predetermined distance.

### Tenth Configuration

According to a tenth configuration, in the above eighth or ninth configuration, the information processing may further include generating the determination two-dimensional data by filtering the first two-dimensional data so that the further away from the coordinate point corresponding to the position on the route the coordinate point is, the more strongly filtered the coordinate point is.

Based on the above, the further away from the route the point is, the more strongly filtered the point is. Thus, for example, it is possible to prevent the value of a determination parameter in a place away from a/the route from rapidly changing.

Another configuration may be an information processing system that executes the above program, or an information processing method performed in an information processing system.

According to the exemplary embodiment, based on determination two-dimensional data, it is possible to make a determination regarding the degree of progress in a wider range.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting diagram showing an example of the entirety of a field F in a virtual space;

FIG. 4 is an example non-limiting diagram showing an example of an intra-base route CA1 set in a base area A1;

FIG. 5 is an example non-limiting diagram showing an example of a game image displayed during a first racing game;

FIG. 6 is an example non-limiting diagram of an inter-base course including an inter-base route R3 as viewed from above the virtual space and is an example non-limiting diagram showing an example of a second racing game on the inter-base course;

FIG. 7 is an example non-limiting diagram showing the state where the degrees of progress of progress objects are determined when long line segments are set along the inter-base route R3;

FIG. 8 is an example non-limiting diagram conceptually illustrating determination two-dimensional data M;

FIG. 9 is an example non-limiting diagram for describing a method for calculating the degree of progress of a player object 31 based on the determination two-dimensional data M;

FIG. 10 is an example non-limiting diagram showing an example of a game image displayed during the second racing game using an inter-base course;

FIG. 11 is an example non-limiting diagram showing a first step for generating intermediate data and the state where determination parameters is set on the inter-base route R3;

FIG. 12 is an example non-limiting diagram showing an example of an inter-base route R having branches between a starting point and a goal point;

FIG. 13 is an example non-limiting diagram for describing a second step for generating the intermediate data and is an example non-limiting diagram showing the state where determination parameters are set for points in a road 50;

FIG. 14 is an example non-limiting diagram showing a third step for generating intermediate data and the state where the values of the determination parameters are set for points in a runnable region 51 other than the road 50;

FIG. 15 is an example non-limiting diagram showing examples of various pieces of data used in a generation process for generating the determination two-dimensional data that is shown in FIG. 16;

FIG. 16 is an example non-limiting flow chart showing an example of a generation process;

FIG. 17 is an example non-limiting diagram showing examples of various pieces of data used in a racing game process shown in FIG. 18; and

FIG. 18 is an example non-limiting flow chart showing an example of a racing game process.

### DETAILED DESCRIPTION OF NON-LIMITING EXAMPLE EMBODIMENTS

### Game System Configuration

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of buttons (an A-button, a B-button, an X-button, a Y-button, an L-button, and an R-button) and an analog stick, as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

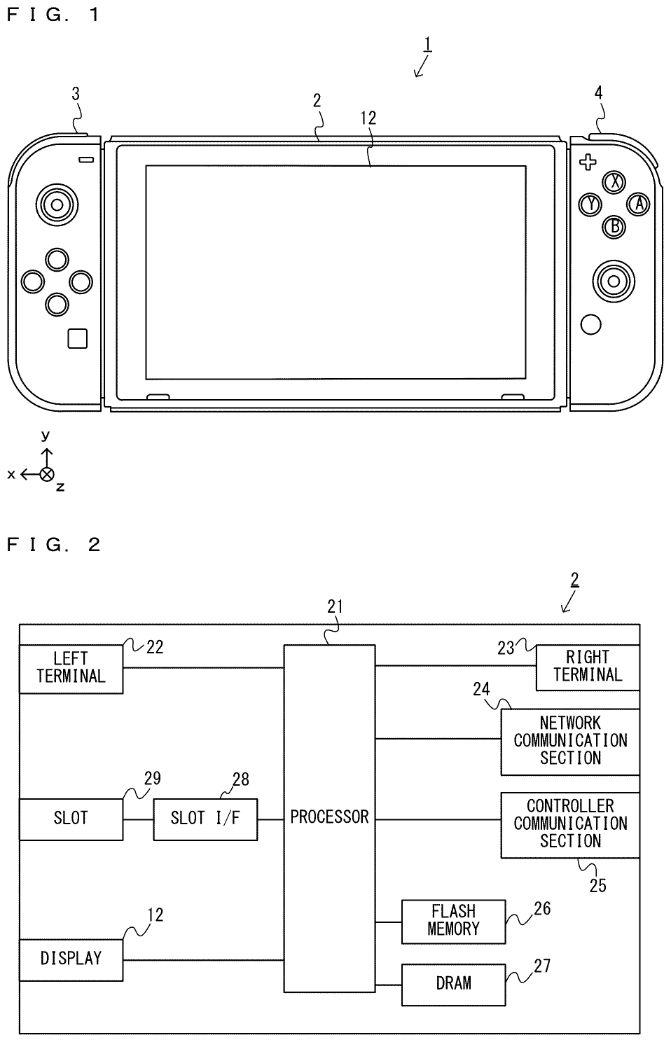

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., an external display device such as a television) separate from the display 12.

### Overview of Game

Next, an overview of a game executed by the game system 1 is described. The game according to the exemplary embodiment is a racing game where a player progresses a player object in a virtual space using the controllers. The player object runs on a route set on a field in the virtual space, flies in the virtual space, and moves under water in the virtual space during the racing game.

The racing game according to the exemplary embodiment has a single play mode where the racing game is performed by a single player, and a multiplay mode where the racing game is performed by a plurality of players. In the single play mode, the racing game is performed using a player object operated by a player and a plurality of progress objects controlled by the processor 21. In the multiplay mode, the racing game is performed using a plurality of progress objects operated by a plurality of players. For example, the racing game is performed in the multiplay mode by connecting a plurality of controllers to a single main body apparatus 2 and by a plurality of players operating player objects corresponding to the plurality of players themselves using the controllers. Alternatively, the racing game is performed in the multiplay mode by connecting a plurality of main body apparatuses 2 directly or via a network (e.g., the Internet) and by a plurality of players operating player objects corresponding to the plurality of players themselves using controllers connected to the main body apparatuses 2.

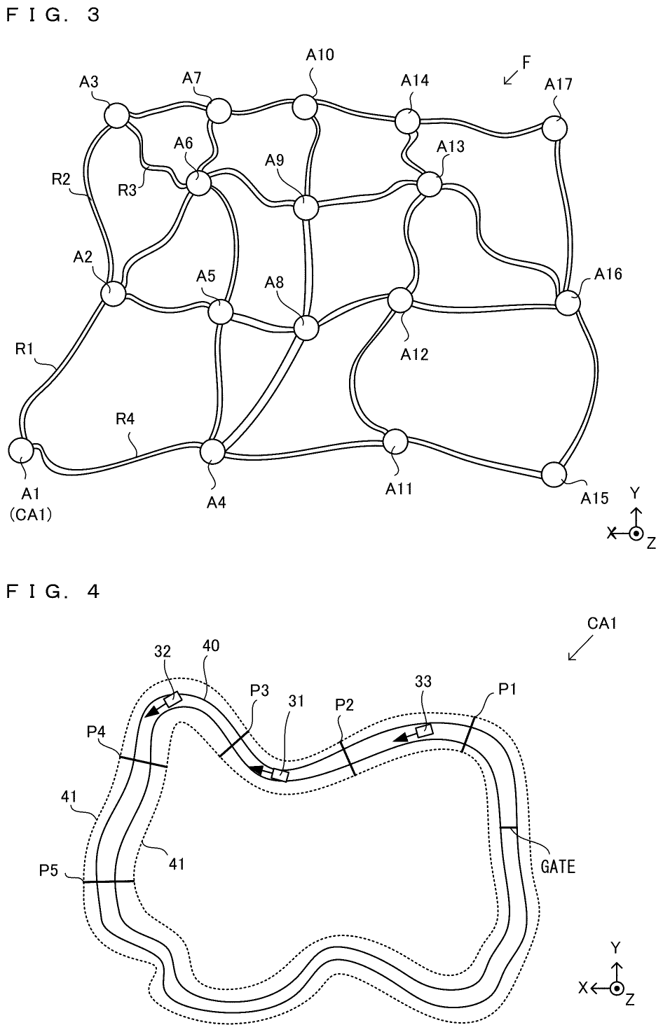

Here, a description is given of a field in the virtual space where the racing game according to the exemplary embodiment is performed. FIG. 3 is a diagram showing an example of the entirety of a field F in the virtual space.

In the exemplary embodiment, a broad field F is set in the virtual space (a three-dimensional space defined by an XYZ orthogonal coordinate system; also referred to as a “game space”). For example, the field F is set parallel to an XY plane. The field F may undulate in a height direction. Various courses are set on the field, and the racing game is performed on the various courses.

As shown in FIG. 3, a plurality of base areas A are set on the field F in the virtual space. For example, as the plurality of base areas A, base areas A1 to A17 are represented as circles. Each base area A includes an intra-base route CA where the player object corresponding to the player can perform a racing game. For example, the base area A1 is an area indicating a single city. The base area A1 includes an intra-base route CA1 formed by a road where the player object can be caused to run.

A plurality of base areas are linked together by an inter-base route R where the player object can be caused to run. For example, the base areas A1 and A2 are linked together by an inter-base route R1. The base areas A2 and A3 are linked together by an inter-base route R2.

In the exemplary embodiment, a first racing game where a player object and other progress objects race each other on a course where the objects take multiple laps around an intra-base route CA provided in a base area A (hereinafter referred to as an “intra-base course”) may be performed. In the exemplary embodiment, a second racing game where a player object and other progress objects race each other on a course where the objects pass through an inter-base route R connecting a first base area and a second base area (hereinafter referred to as an “inter-base course”) may be performed.

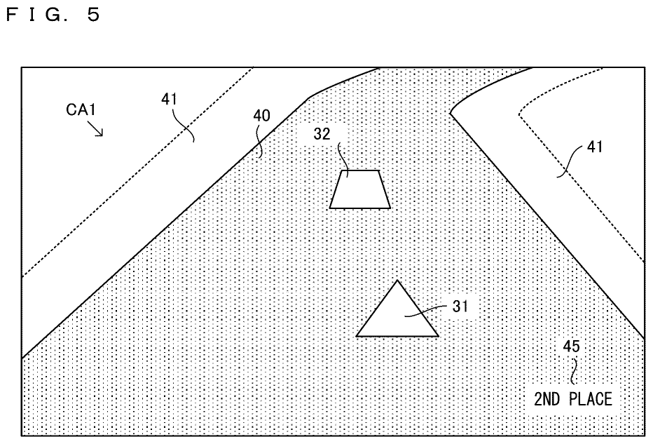

First, the first racing game using an intra-base course is described. FIG. 4 is a diagram of an intra-base course where objects take laps around the intra-base route CA1, as viewed from above the virtual space, and is a diagram showing an example of the first racing game using this intra-base course. FIG. 5 is a diagram showing an example of a game image displayed during the first racing game.

As shown in FIG. 4, in the base area A1, the intra-base route CA1 is provided. The intra-base route CA1 is a route set so that a plurality of progress objects including a player object can take multiple laps around the route. A road 40 (a region surrounded by solid lines) where the plurality of progress objects can move along the intra-base route CA1 is formed. In ranges at a predetermined distance from the edges of the road 40, runnable regions 41 (regions surrounded by the edges of the road 40 and dashed lines) are set. For example, the runnable regions 41 are side roads of the road 40. On the intra-base route CA1, a gate that can be a starting point and a goal point is provided.

As shown in FIG. 4, for example, the racing game is performed by progress objects 31 to 33. For example, the progress object 31 is a player object operated by a first player. The progress object 32 is a player object controlled by a second player, and a progress object 33 is a progress object controlled by the processor 21. In addition to the progress objects 31 to 33, a plurality of progress objects controlled by other players or the processor 21 can participate in the racing game.

Hereinafter, the progress object 31 operated by the first player is referred to as the “player object 31”. The progress object controlled by the second player is referred to as the “progress object 32”, and the progress object controlled by the processor 21 is referred to as the “progress object 33”.

If the first racing game is started, the plurality of progress objects including the player object 31, the progress object 32, and the progress object 33 start from the starting point (the gate) of the intra-base route CA1. The plurality of progress objects can run on the road 40 set along the intra-base route CA1 or the runnable regions 41 beyond the road 40. The progress objects may be able to temporarily separate from the road 40 or the runnable regions 41 and progress in the air during the racing game. The plurality of progress objects take multiple laps around the intra-base route CA1 and then reach the goal point (the gate) of the intra-base route CA1.

As shown in FIG. 5, a display device (the display 12 or an external display device) of the main body apparatus 2 displays a game image based on a virtual camera set behind the player object 31 corresponding to the main body apparatus 2. In FIG. 5, the player object 31 is running on the road 40 that forms the intra-base route CA1, and the progress object 32 operated by the second player is displayed in front of the player object 31. Ranking display 45 is also displayed, and the ranking display 45 displays the current ranking of the player object 31.

The plurality of progress objects basically run on the road 40, but can run on the runnable regions 41 beyond the road 40. When a progress object runs on the runnable regions 41, the velocity of the progress object is slower than when the progress object runs on the road 40. The plurality of progress objects cannot run beyond the runnable regions 41. For example, if a progress object goes beyond the runnable regions 41, the progress object is automatically returned onto the road 40. Although FIG. 5 shows dashed lines indicating the runnable regions 41, the dashed lines are not displayed in an actual game image.

As shown in FIG. 4, on the intra-base course, a plurality of determination positions P are set to determine the degrees of progress in the racing game of the progress objects. For example, the plurality of determination positions P (e.g., P1 to P5 shown in FIG. 4) are set in ascending order of the distance from the starting point. The plurality of determination positions P are positions along the intra-base route CA1 from the starting point to the goal point. For example, a determination position P is represented by a line segment having the same length as the combined width of the road 40 and the runnable regions 41 and orthogonal to a line passing through the center of the road 40. The degree of progress in the racing game differs in accordance with each determination position P. Specifically, the longer the distance along the intra-base route CA1 from the starting point is, the higher the degree of progress is. For example, the degree of progress at each determination position P is set to a value from 0 to 1. For example, the degree of progress at the starting point is set to “0”, and the degree of progress at the goal point is set to “1”. For example, the degree of progress at each determination position P is set to a value obtained by dividing the distance from the starting point to the determination position P by the distance of the entirety of the intra-base course along the intra-base route CA1. Although FIG. 4 shows P1 to P5 as the determination positions P for illustrative purposes, actually, more determination positions P are set to make an accurate determination particularly in a curved portion or the like.

Based on the positions along the intra-base route CA1 of the progress objects, the degrees of progress in the racing game of the progress objects are calculated. For example, the degree of progress of the progress object 33 located between the determination positions P1 and P2 is calculated by interpolating (e.g., linearly interpolating) the degree of progress at the determination position P1 and the degree of progress at the determination position P2. Then, the ranking of the player object 31 is determined based on the degrees of progress of the progress objects.

For example, as shown in FIG. 4, the progress object 32 is located between the determination positions P3 and P4. Based on the position along the intra-base route CA1 of the progress object 32, the degree of progress of the progress object 32 is calculated by interpolating the determination positions P3 and P4. The player object 31 is located between the determination positions P2 and P3. Based on the position along the intra-base route CA1 of the player object 31, the degree of progress of the player object 31 is calculated. The progress object 33 is located between the determination positions P1 and P2. Based on the position along the intra-base route CA1 of the progress object 33, the degree of progress of the progress object 33 is calculated. Then, the current ranking of the player object 31 is determined based on the degrees of progress of the progress objects. In the situation shown in FIG. 4, the ranking of the player object 31 is the second place. As shown in FIG. 5, “second place” is displayed as the ranking display 45. The progress objects can separate from the road 40 or the runnable regions 41 and temporarily progress in the air during the first racing game. Also when a progress object is in the air, the degree of progress of the progress object is calculated based on the position in the horizontal direction (the XY coordinate values) of the progress object, and the ranking of the progress object is displayed based on the calculated degree of progress. However, in a case where a race is performed on a route including portions crossing on multiple levels or the like, since there are portions overlapping each other with respect to the horizontal direction, the degree of progress may be calculated further based on the position in the height direction in addition to the horizontal direction.

### Ranking Determination on Inter-Base Course

Next, a ranking determination on an inter-base course is described. In the game according to the exemplary embodiment, the plurality of progress objects can perform the second racing game on an inter-base course including an inter-base route R connecting a first base area and a second base area. In the second racing game, the plurality of progress objects can run in a wide range on the field including the inter-base route R.

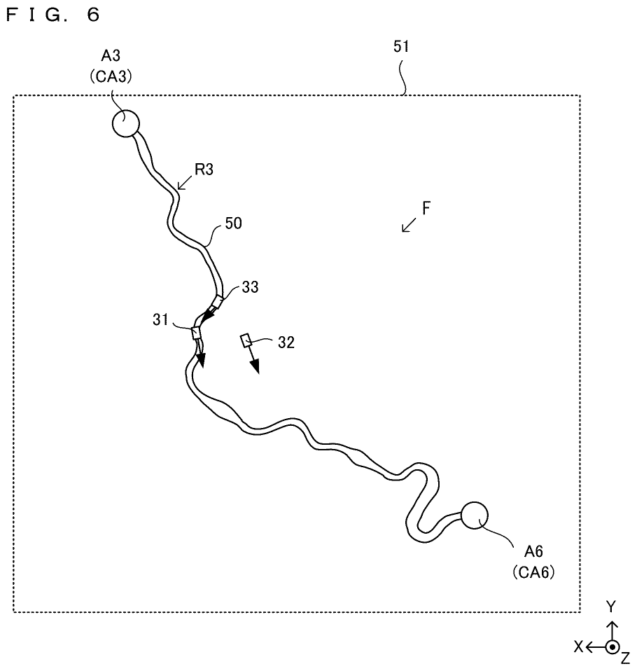

FIG. 6 is a diagram of an inter-base course including an inter-base route R3 as viewed from above the virtual space and is a diagram showing an example of the second racing game on the inter-base course. As shown in FIG. 6, on the field, the base areas A3 and A6 are set, and an inter-base route R3 connecting the base areas A3 and A6 is set.

For example, the player object 31 and the progress objects 32 and 33 perform the second racing game on an inter-base course where the objects start from the base area A3, pass through the inter-base route R3, and reach the base area A6. The inter-base route R3 is a route where the plurality of progress objects are recommended to move, and for example, is formed of a road 50.

In the second racing game, the plurality of progress objects can both run on the inter-base route R3 (on the road 50) and run through a position outside the inter-base route R3 on the field F. Specifically, the plurality of progress objects can run on a runnable region 51 (a region surrounded by a dashed line except for the road 50) that is a wide range on the field F. For example, in FIG. 6, the player object 31 and the progress object 33 are running on the inter-base route R3, but the progress object 32 is running on the runnable region 51, which is not on the inter-base route R3. The plurality of progress objects may be able to temporarily separate from the road 50 and the runnable region 51 and progress in the air during the racing game. The runnable region 51 includes a water region, and the progress objects may be able to progress on water or under water.

The moving velocity of a progress object when the progress object runs through a position other than the inter-base route R3 on the field is slower than the moving velocity of the progress object when the progress object runs on the inter-base route R3. On the other hand, since the inter-base route R3 includes curved portions, the distance to a goal point may be shorter in a case where the progress object runs through a position other than the inter-base route R3 than in a case where the progress object runs on the inter-base route R3. The player can perform the racing game while selecting whether to cause the player object corresponding to the player themselves to run on the inter-base route R3 or take a shortcut by deviating from the inter-base route R3 and running on the runnable region 51.

In the above first racing game, the degrees of progress of the progress objects are calculated based on determination positions set along an intra-base route, and the ranking of the player object during the racing game is determined based on the degrees of progress of the progress objects. On the other hand, in the second racing game, the progress objects can run in a wide range on the field F. On a course where the progress objects can run in such a wide range, it may be difficult to set determination positions along the inter-base route R3 and determine an accurate ranking. For example, in a case where, similarly to the above first racing game, a long line segment extending to the inter-base route R3 in the runnable region 51 is set by extending a line segment perpendicular to a line passing through the center of the inter-base route R3 along the inter-base route R3, and the degrees of progress of the progress objects are calculated based on the line segment, it may be difficult to determine an accurate ranking.

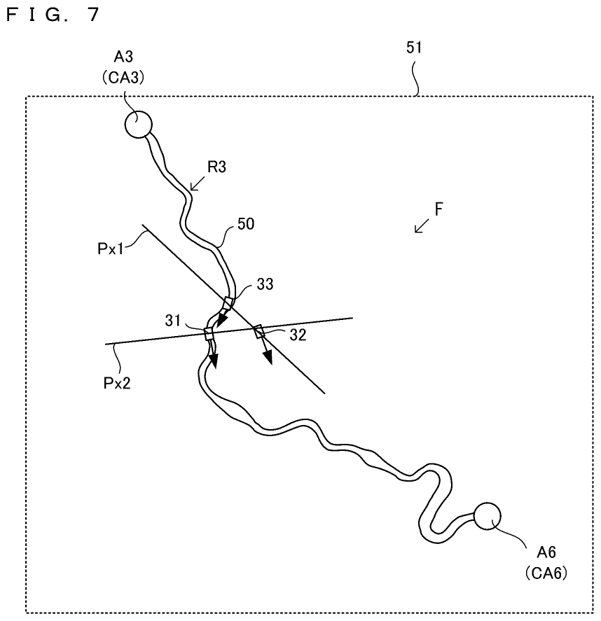

FIG. 7 is a diagram showing the state where the degrees of progress of the progress objects are determined when long line segments are set along the inter-base route R3. As shown in FIG. 7, a case is assumed where a long line segment Px1 and a long line segment Px2 perpendicular to a line passing through the center of the inter-base route R3 are set along the inter-base route R3. The line segment Px2 is closer to the goal point, and therefore, the degree of progress at the line segment Px2 is higher than that at the line segment Px1. The progress object 33 is running on the road 50 and is located on the line segment Px1. The player object 31 is running on the road 50 and is located on the line segment Px2. In this case, the degree of progress of the player object 31 is higher than the degree of progress of the progress object 33. Thus, it is determined that the player object 31 ranks higher than the progress object 33. On the other hand, the progress object 32 is located at the position where the line segments Px1 and Px2 overlap each other. Thus, it can be determined that the degree of progress of the progress object 32 is the same as that of the progress object 33, or it can also be determined that the degree of progress of the progress object 32 is the same as that of the player object 31. As described above, in a case where the progress objects can run in a wide range on the field, it may be difficult to calculate the accurate degrees of progress of the progress objects based on long line segments perpendicular to the inter-base route R3. Thus, it may be difficult to accurately determine the current ranking of the player object 31.

Accordingly, in the exemplary embodiment, on an inter-base course where the progress objects can run in a wide range on the field, the degrees of progress of the progress objects may be determined based on determination two-dimensional data M. The determination two-dimensional data M is two-dimensional data corresponding to two-dimensional coordinate points with respect to the horizontal direction (the XY direction) in the virtual space including an inter-base route R and is data in which a determination parameter indicating the degree of progress is set with respect to each coordinate point. The determination two-dimensional data M is a two-dimensional map as a set of coordinate points indicating positions on the XY plane in the virtual space including the inter-base route R, and a determination parameter is set with respect to each coordinate point. Specifically, in the determination two-dimensional data M, a first value is set as the determination parameter of a coordinate point corresponding to a starting point, and a second value is set as the determination parameter of a coordinate point corresponding to a goal point. In the determination two-dimensional data M, a value from the first value to the second value is set as the determination parameter of a coordinate point corresponding to any position (a position in the road 50 and a position in the runnable region 51) between the starting point and the goal point.

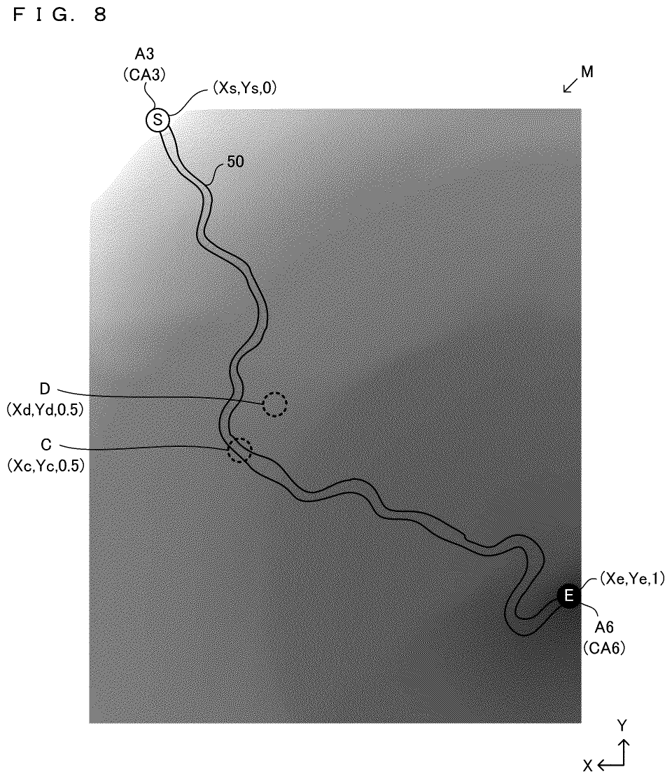

FIG. 8 is an example of a diagram conceptually illustrating the determination two-dimensional data M.

A grayscale image shown in FIG. 8 indicates the degrees of progress at positions in the road 50 and the runnable region 51. Specifically, the density of each coordinate point in the grayscale image represents the value of a determination parameter p at the point. In FIG. 8, the density of each coordinate point is represented as follows. The closer to “0” the value of the determination parameter p at the point is, the closer to white the color of the point is. The closer to “1” the value of the determination parameter p at the point is, the closer to black the color of the point is. In FIG. 8, the base area A3 as the starting point is represented by a character “S”, and the base area A6 as the goal point is represented by a character “E”. The base areas A3 and A6 are connected together by the inter-base route R3.

In FIG. 8, the coordinate values and the determination parameter of each point are represented as (X, Y, p). For example, the position of the base area A3 as the starting point is represented as coordinate values (Xs, Ys), and “0” is set as the value of the determination parameter p at this position. Thus, the coordinate values and the determination parameter of the base area A3 as the starting point are represented as (Xs, Ys, 0). The position of the base area A6 as the goal point is represented as coordinate values (Xe, Ye), and “1” is set as the value of the determination parameter p at this position. Thus, the coordinate values and the determination parameter of the base area A6 as the goal point are represented as (Xe, Ye, 1).

As shown in FIG. 8, the color of a point is close to white on the periphery of the starting point, and the color of a point is close to black on the periphery of the goal point. At a position further away from the goal point than from the starting point, the color of a point is white, which is the same as the starting point. The values of the determination parameters of these points are set to “0”. The grayscale image is gray between the starting point and the goal point. The closer to the goal point the point is, the closer to black the color of the point is. For example, it is indicated that positions C and D surrounded by two dashed lines in FIG. 8 are of a gray color having the same density, and the values of the determination parameters at these positions are the same as each other. For example, the values of the determination parameters at the position C (Xc, Yc) and the position D (Xd, Yd) are set to “0.5”, which indicates the midpoint of an inter-base course.

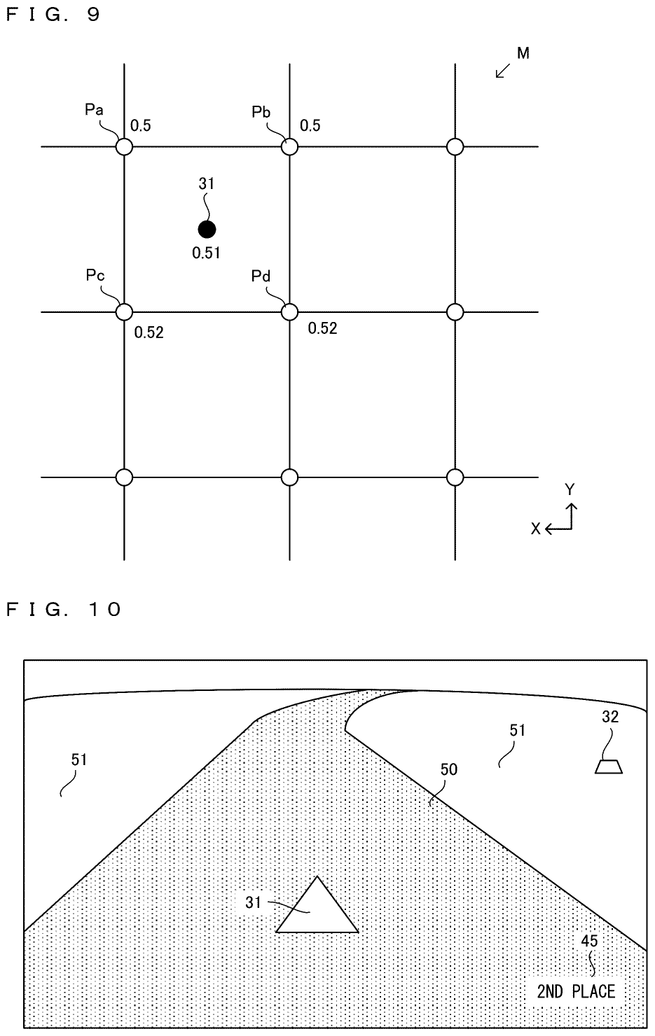

The degrees of progress in the racing game of the progress objects are calculated based on the determination two-dimensional data M. FIG. 9 is a diagram for describing a method for calculating the degree of progress of the player object 31 based on the determination two-dimensional data M. In FIG. 9, white circles indicate coordinate points stored in the determination two-dimensional data M, and the determination parameter is set with respect to each coordinate point. As shown in FIG. 9, the coordinate points included in the determination two-dimensional data M are at intervals of a predetermined distance. The degree of progress of the player object 31 is calculated by, for example, linearly interpolating the values of the determination parameters of points Pa to Pd on the periphery of the position in the horizontal direction in the virtual space (the XY coordinate values) of the player object 31. For example, if “0.5” is set for the points Pa and Pb and “0.52” is set for the points Pc and Pd, the degree of progress of the player object 31 is calculated as “0.51”.

The degrees of progress of the progress objects are calculated based on the determination two-dimensional data M, and the current ranking of the player object 31 is calculated based on the calculated degrees of progress of the progress objects. Then, the calculated ranking is displayed as the ranking display 45 during the racing game.

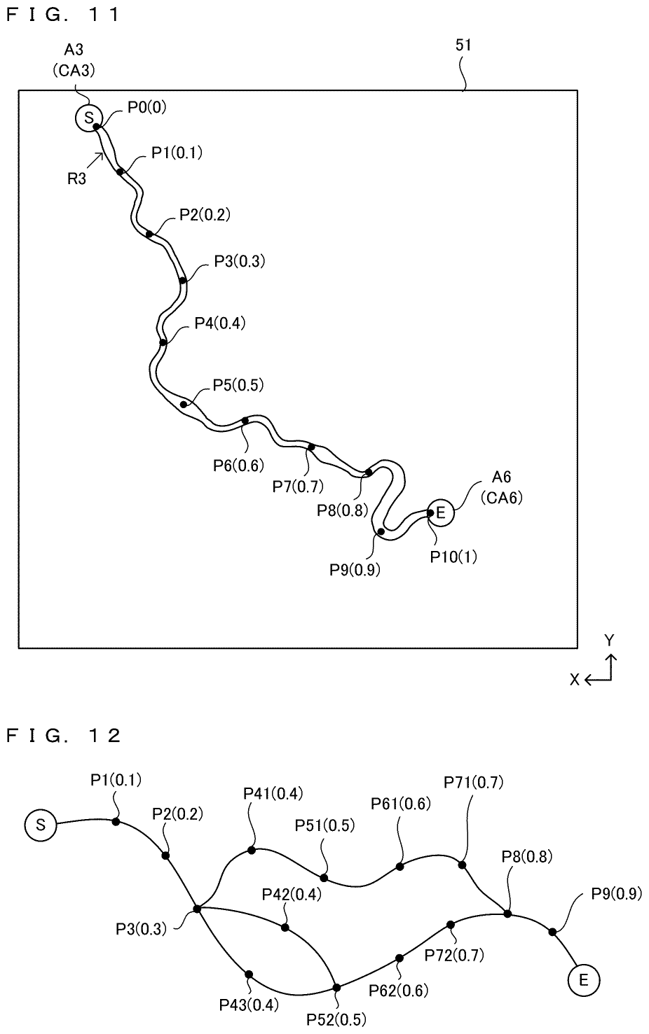

FIG. 10 is a diagram showing an example of a game image displayed during the second racing game using an inter-base course. As shown in FIG. 10, the player object 31 is running on the road 50, and the progress object 32 is running on the runnable region 51 away from the road 50. The degrees of progress of the progress objects are calculated based on the determination two-dimensional data M, and the current ranking of the player object 31 calculated based on the degrees of progress of the progress objects is displayed as the ranking display 45. The progress objects can separate from the road 50 or the runnable region 51 and temporarily progress in the air during the second racing game. When a progress object is in the air, the degree of progress of the progress object is calculated based on the position in the horizontal direction (the XY coordinate values) of the progress object.

In the exemplary embodiment, the determination two-dimensional data M is generated in advance by a game creator and stored in the main body apparatus 2. Hereinafter, a method for generating the determination two-dimensional data M is described.

### Method for Generating Determination Two-Dimensional Data

The determination two-dimensional data M is generated based on intermediate data. Similarly to the determination two-dimensional data M, the intermediate data is two-dimensional data corresponding to two-dimensional coordinate points with respect to the horizontal direction in the virtual space including an inter-base route R. A determination parameter is set with respect to each coordinate point.

FIG. 11 is a diagram showing a first step for generating the intermediate data and the state where the determination parameters are set on the inter-base route R3.

As shown in FIG. 11, first, “0” is set as the determination parameter of a point P0 corresponding to the starting point of the inter-base course, and “1” is set as the determination parameter of a point P10 corresponding to the goal point of the inter-base course. Next, for example, points P1 to P9 are set on a line passing through the center of the road 50 that forms the inter-base route R3. Hereinafter, the line passing through the center of the road 50 that forms an inter-base route R is referred to as a “route path”. The number of points set on the route path is not limited to nine, and may be greater or smaller than nine.

The value of the determination parameter of each point is set in the range of “0” to “1”. Specifically, the value of the determination parameter of each point is set so that the closer to the starting point the point is, the closer to “0” the value of the determination parameter of the point is, and the closer to the goal point the point is, the closer to “1” the value of the determination parameter of the point is. For example, the points P1 to P9 may be set so that the distances along the inter-base route R between the points are at regular intervals, and the values of the determination parameters of the points P1 to P9 may be set in accordance with the distances along the inter-base route R from the starting point. For example, “0.1” may be set for the point P1, which is the closest to the starting point, and “0.5” may be set for the point P5, which is midway between the starting point and the goal point regarding the distance along the inter-base route R. “0.9” may be set for the point P9, which is the closest to the goal point.

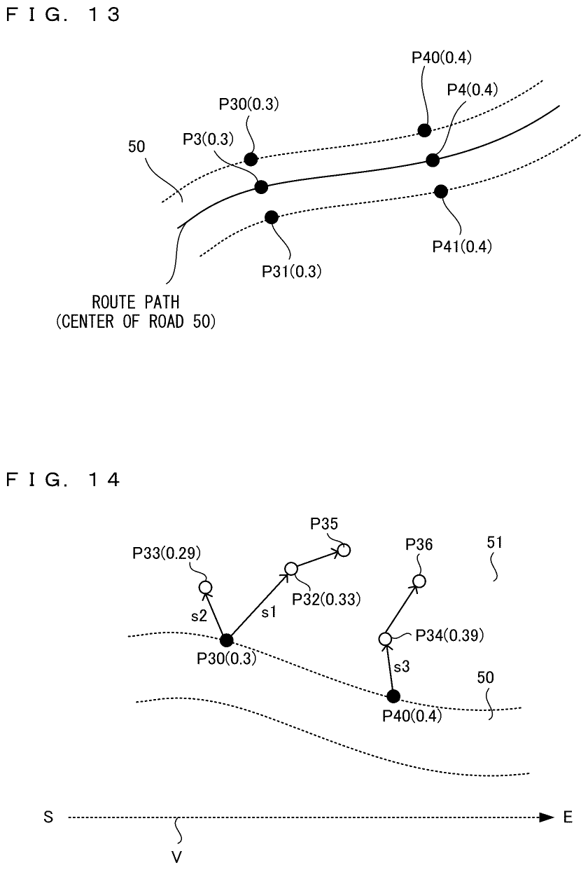

In a case where an inter-base route R has branches, points are also set on the branching roads. The positions and the values of the determination parameters of the points are set taking into account the proportion of curves. FIG. 12 is a diagram showing an example of an inter-base route R having branches between a starting point and a goal point. As shown in FIG. 12, in a case where an inter-base route R has branches between a starting point and a goal point, points are also set on the branching roads. For example, in the example shown in FIG. 12, the inter-base route R branches into three paths at a point P3, and points P41, P42, and P43 are set on the branching roads. The same value “0.4” is set as the values of the determination parameters of the points P41, P42, and P43. Also in a case where the distances along the branching roads are different from each other, the value of the determination parameter is set to be the same at a junction.

The positions and the values of the determination parameters of the points on the route path are automatically set based on a program. The positions and the values of the determination parameters of the points on the route path may be set by the game creator.

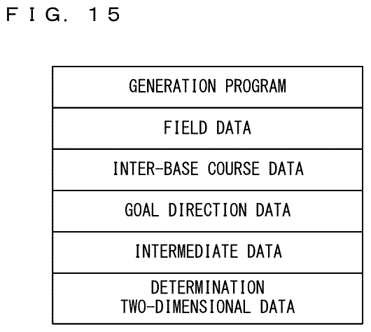

Next, based on the points P0 to P10 on the route path on which the determination parameters shown in FIG. 11 are set, the values of the determination parameters of the points in the inter-base route R3 (the road 50) are set. FIG. 13 is a diagram for describing a second step for generating the intermediate data and is a diagram showing the state where determination parameters are set for points in the road 50.

In FIG. 13, a solid line indicates the route path, and dashed lines indicate the edges in the width direction of the road 50. As shown in FIG. 13, based on the values of the determination parameters of the points set in the first step, the values of points in the road 50 are set. For example, points P30 and P31 where a line passing through the point P3 on the route path set in the first step and perpendicular to the route path and both edges of the road 50 intersect each other are set. For the points P30 and P31, “0.3”, which is the same value as that of the point P3, is set as the values of the determination parameters. Points P40 and P41 where a line passing through the point P4 on the route path and perpendicular to the route path and both edges of the road 50 intersect each other are set. For the points P40 and P41, “0.4”, which is the same value as that of the point P4, is set as the values of the determination parameters. In the road 50, a plurality of points may be further set at random intervals or intervals set in advance.

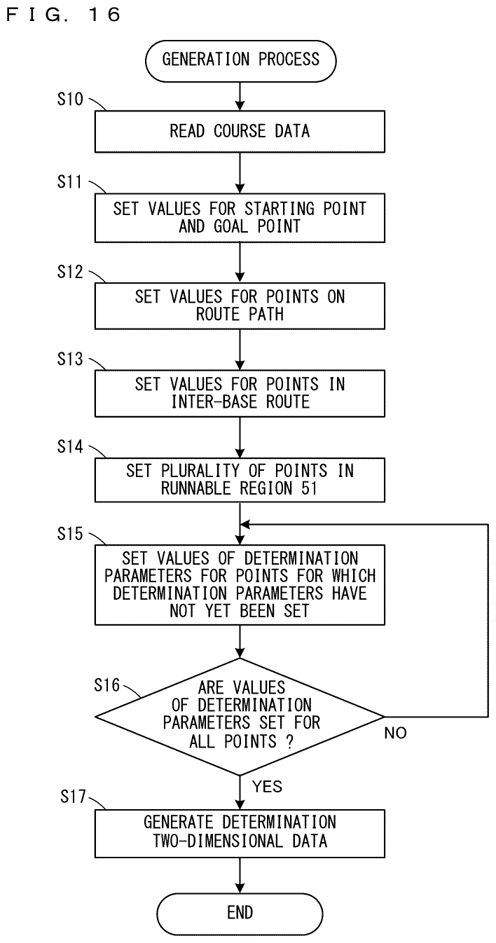

Next, based on the values of the points set on the road 50, the values of points in the runnable region 51 other than the road 50 are calculated. FIG. 14 is a diagram showing a third step for generating the intermediate data and the state where the values of the determination parameters are set for points in the runnable region 51 other than the road 50.

In FIG. 14, blacked-out circles indicate points for which the values of the determination parameters are already set. White circles indicate points for which the values of the determination parameters have not yet been set and which are points as calculation targets of the determination parameters. First, a plurality of points are randomly set in the runnable region 51 other than the road 50. The method for setting the points in the runnable region 51 may be any method. For example, a plurality of points may be randomly set in the runnable region 51, the runnable region 51 may be subjected to Voronoi division based on the set points, and the vertices of the generated Voronoi regions may be set. For example, as shown in FIG. 14, points P32 to P36 and the like are set.

Next, the values of the determination parameters are calculated and set for the randomly set points. Specifically, the value of the determination parameter of a point for which the determination parameter has not yet been set (a point as a calculation target) is calculated based on the value of the closest point (the nearest neighbor point) among the points for which the determination parameters are already set, a vector s from the nearest neighbor point to the point as the calculation target, and a vector V (a unit vector) from the starting point to the goal point. The value of the determination parameter of the point as the calculation target is set so that the closer to the goal point the point is, the greater the value is. More specifically, if the angle between the vectors s and V is less than 90 degrees, the value of the point as the calculation target is greater than the value of the nearest neighbor point. The smaller the angle is, the greater the value of the point as the calculation target is. In this case, the greater the magnitude of the vector s is, the greater the value of the point as the calculation target is. If the angle between the vectors s and V is 90 degrees, the value of the point as the calculation target is the same as the value of the nearest neighbor point. If the angle between the vectors s and V exceeds 90 degrees, the value of the point as the calculation target is smaller than the value of the nearest neighbor point. The greater the angle is, the smaller the value of the point as the calculation target is. The greater the magnitude of the vector s is, the smaller the value of the point as the calculation target is. For example, the value of the determination parameter of the point as the calculation target may be calculated based on the sum of the value of the determination parameter of the nearest neighbor point and a value obtained by dividing the inner product of the vectors s and V by the straight-line distance from the starting point to the goal point.

For example, the value of the determination parameter of the point P32 as a calculation target is calculated based on the value of the determination parameter of the point P30 as the nearest neighbor point (0.3), a vector s1 from the point P30 to the point P32, and the vector V. Since the angle between the vectors s1 and V is less than 90 degrees, the value of the determination parameter of the point P32 is greater than the value of the determination parameter of the point P30. For example, the value of the determination parameter of the point P32 may be calculated based on the sum of the value of the determination parameter of the point P30 and a value obtained by dividing the inner product of the vectors s1 and V by the straight-line distance from the starting point to the goal point. For example, “0.33” is calculated as the value of the determination parameter of the point P32.

For example, the value of the determination parameter of the point P33 as a calculation target is calculated based on the value of the determination parameter of the point P30 as the nearest neighbor point, a vector s2 from the point P30 to the point P33, and the vector V. Since the angle between the vectors s2 and V is greater than 90 degrees, the value of the determination parameter of the point P33 is smaller than the value of the determination parameter of the point P30. For example, “0.29” is calculated as the value of the determination parameter of the point P33.

Similarly, the value of the determination parameter of the point P34 as a calculation target is calculated based on the value of the determination parameter of the point P40 as the nearest neighbor point (0.4), a vector s3 from the point P40 to the point P34, and the vector V. For example, “0.39” is calculated as the value of the determination parameter of the point P34.

Further, based on the points for which the determination parameters are set, the value of a point for which the determination parameter has not yet been set is calculated. For example, the value of the determination parameter of the point P35 as a calculation target is calculated based on the point P32 as the nearest neighbor point among the points for which the determination parameters are already set. The value of the determination parameter of the point P36 as a calculation target is calculated based on the point P34 as the nearest neighbor point among the points for which the determination parameters are already set. Such a process is repeatedly performed, whereby points for which the determination parameters are set are propagated from the inter-base route R3 to the entirety of the runnable region 51. In this manner, intermediate data which includes a plurality of coordinate points and in which the determination parameters are set for the coordinate points is generated.

Next, based on the generated intermediate data, the determination two-dimensional data M is generated. First, regarding the generated intermediate data, a blur process is performed to blur a grayscale image represented by the coordinate points in the intermediate data and the determination parameters set for the coordinate points. By the blur process, the difference between the values of the determination parameters of adjacent points becomes small, and the colors smoothly change in a case where the intermediate data is represented by an image. Specifically, correction is performed so that the further away from the inter-base route R3 the point is, the more strongly filtered the point is (the higher the degree of the correction on the point is). As described above, when the intermediate data is generated, first, the values of the determination parameters of points in the inter-base route R3 are set, and based on the set values, the values of points near the inter-base route R3 are set. Further, based on the set values of the points near the inter-base route R3, the values of other points are set. As described above, points for which the determination parameters are set spread in a propagative manner from the inter-base route R3. Thus, an error may be great at a point away from the inter-base route R3, and the difference between the values of the determination parameters of adjacent points may be great. If the difference between the values of the determination parameter of adjacent points is great, the degree of progress of a progress object rapidly changes. Thus, the blur process is performed on the intermediate data so that the further away from the inter-base route R3 the point is, the more strongly filtered the point is.

Then, the determination two-dimensional data M is generated from the intermediate data subjected to the blur process. Coordinate points included in the intermediate data are randomly set, and the distances between the coordinate points are averagely a first distance (e.g., 20 m in the virtual space). In the determination two-dimensional data M, a plurality of coordinate points are set so that the distances between the coordinate points are a second distance (e.g., 5 m in the virtual space) shorter than the first distance, and the coordinate points are at regular intervals. The value of the determination parameter of each point in the determination two-dimensional data M is calculated by interpolating (e.g., linearly interpolating) the values of the determination parameters of a plurality of points on the periphery of the point in the intermediate data.

For example, the generated determination two-dimensional data M is stored with a game program in an external storage medium attached to the slot 29. The external storage medium is attached to the slot 29 of the main body apparatus 2. If the player gives an instruction to start the second racing game, the game program for executing the racing game and the determination two-dimensional data M are read from the external storage medium into a memory (e.g., the DRAM 27) of the main body apparatus 2. During the second racing game, the processor 21 of the main body apparatus 2 calculates the degrees of progress of the progress objects based on the determination two-dimensional data M stored in the memory and the positions of the progress objects and determines the current ranking of the player object 31 based on the calculated degrees of progress of the progress objects. The generated determination two-dimensional data M may be stored with the game program (or separately from the game program) in a server on the Internet, and the determination two-dimensional data M may be downloaded to the main body apparatus 2 by the main body apparatus 2 accessing the server.

As described above, determination two-dimensional data is prepared in advance, and the rankings of progress objects during the racing game are determined based on the determination two-dimensional data. In the exemplary embodiment, a plurality of inter-base courses are prepared, and the determination two-dimensional data is prepared in advance with respect to each inter-base course.

### Details of Processing

Next, a description is given of the details of a process for generating the above determination two-dimensional data and a racing game process.

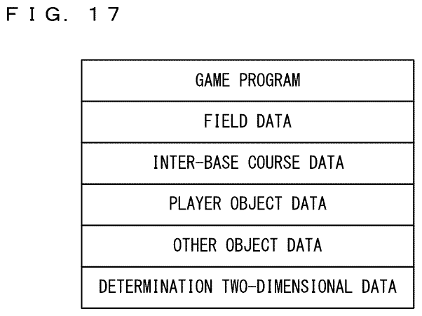

FIG. 15 is a diagram showing examples of various pieces of data used in a generation process for generating the determination two-dimensional data that is shown in FIG. 16. The various pieces of data shown in FIG. 15 are stored in a storage device (e.g., a DRAM, a non-volatile memory, a hard disk, or the like) of a generation apparatus for generating the determination two-dimensional data. For example, the generation apparatus is a computer owned by the game creator.

As shown in FIG. 15, the storage device of the generation apparatus stores a generation program, field data, inter-base course data, goal direction data, the intermediate data, and the determination two-dimensional data.

The generation program is a program for executing a generation process described below (a process shown in FIG. 16).

The field data is data indicating the entirety of the field F. The field data includes data indicating a plurality of base areas and data indicating a plurality of inter-base routes.

The inter-base course data is data regarding an inter-base course for which the determination two-dimensional data is generated. The inter-base course is a course including an inter-base route connecting a first base area and a second base area.

The goal direction data is data indicating a direction from a starting point set on the inter-base course to a goal point set on the inter-base course and is data indicating a unit vector (the vector V) in the direction from the starting point to the goal point.

The intermediate data is data for generating the determination two-dimensional data. The intermediate data is two-dimensional data corresponding to two-dimensional coordinate points with respect to the horizontal direction in the virtual space including an inter-base route R and is data in which the determination parameter indicating the degree of progress is set with respect to each coordinate point.

The determination two-dimensional data is data generated based on the intermediate data. The determination two-dimensional data is two-dimensional data corresponding to two-dimensional coordinate points with respect to the horizontal direction in the virtual space including an inter-base route R and is data in which the determination parameter indicating the degree of progress is set with respect to each coordinate point.

### Generation Process

Next, a generation process for generating the determination two-dimensional data is described. FIG. 16 is a flow chart showing an example of the generation process. The generation process shown in FIG. 16 is executed by the computer of the generation apparatus owned by the game creator.

First, the generation apparatus reads course data of an inter-base course (step S10).

Next, the generation apparatus sets the value of the determination parameter for each of a starting point and a goal point on the inter-base course (step S11). Specifically, in the intermediate data, the generation apparatus sets a coordinate point corresponding to the starting point of the inter-base course and sets “0” as the value of the determination parameter of the coordinate point corresponding to the starting point. In the intermediate data, the generation apparatus also sets a coordinate point corresponding to the goal point of the inter-base course and sets “1” as the value of the determination parameter of the coordinate point corresponding to the goal point.

Next, the generation apparatus sets the values of the determination parameters for points on a route path (step S12). Here, in the intermediate data, the generation apparatus sets a plurality of points on a route path (a center line of a road 50 that forms an inter-base route R) and sets a value from “0” to “1” as the value of the determination parameter of each set point. Specifically, the generation apparatus sets the value of the determination parameter of each point so that the closer to the starting point the point is, the closer to “0” the value is, and the closer to the goal point the point is, the closer to “1” the value is.

Next, the generation apparatus sets the values of the determination parameters for points in the inter-base route R (step S13). Here, in the intermediate data, the generation apparatus sets a plurality of points in the inter-base route R (the road 50) and sets a value from “0” to “1” as the value of the determination parameter of each set point. For example, the generation apparatus sets the values of the determination parameters of points on a line passing through a point set on the route path and perpendicular to the route path to be the same as the value of the determination parameter of a point on the route path. The generation apparatus also sets the value of the determination parameter of a point located between two points set on the route path by interpolating the value of the determination parameters set for the two points.

Next, the generation apparatus sets a plurality of points in a runnable region 51 outside the inter-base route R (step S14). Here, in the intermediate data, a plurality of points are randomly set in the runnable region 51. Here, only the coordinate values of the points are set, and the values of the determination parameters are not set for the coordinate points. The method for setting a plurality of points in the intermediate data may be any method. For example, the generation apparatus may randomly set a plurality of points in the runnable region 51, perform Voronoi division on the runnable region 51 based on the set points, and set the vertices of the generated Voronoi regions in the intermediate data.

Next, the generation apparatus sets the values of the determination parameters for points for which the determination parameters have not yet been set (step S15). Here, the value of the determination parameter for a point for which the determination parameter has not yet been set (a point as a calculation target) and which is adjacent to a point for which the determination parameter is already set is calculated and set. Specifically, the value of the determination parameter of the point as the calculation target is calculated based on the value of the determination parameter of the nearest neighbor point among points for which the determination parameters are already set, the vector s from the nearest neighbor point to the point as the calculation target, and the vector V from the starting point to the goal point.

Next, the generation apparatus determines whether or not the values of the determination parameters are set for all the points set in step S14 (step S16).

If the determination is NO in step S16, the generation apparatus executes the process of step S15 again. The process of step S15 is repeatedly executed until the values of the determination parameters are set for all the points set in step S14. Consequently, the intermediate data is generated.

If the determination is YES in step S16, the generation apparatus generates the determination two-dimensional data based on the generated intermediate data (step S17). Specifically, the generation apparatus performs a blur process on the intermediate data generated by repeatedly executing the process of step S15. Here, the generation apparatus performs the blur process so that the further away from the inter-base route R the point is, the more strongly filtered the point is. Then, the generation apparatus generates the determination two-dimensional data based on the intermediate data subjected to the blur process. For example, if the coordinate values of a certain point in the determination two-dimensional data and the coordinate values of a certain point in the intermediate data match each other, the generation apparatus copies the value of the determination parameter of the certain point in the intermediate data to the value of the determination parameter of the certain point in the determination two-dimensional data. If the coordinate values of a certain point in the determination two-dimensional data and the coordinate values of a certain point in the intermediate data do not match each other, the generation apparatus calculates the determination parameter of the certain point in the determination two-dimensional data by interpolating the values of the determination parameters of a plurality of points on the periphery of the certain point in the intermediate data.

If the process of step S17 is performed, the generation apparatus ends the generation process shown in FIG. 16.

In the game according to the exemplary embodiment, a plurality of inter-base courses are prepared. The plurality of inter-base courses include a first inter-base course where a ranking determination is made based on the determination two-dimensional data, and a second inter-base course where a ranking determination is made not based on the determination two-dimensional data and by a method similar to that for the above intra-base course. The generation apparatus generates the determination two-dimensional data for each first inter-base course.

Next, a description is given of a process in a case where the main body apparatus 2 performs the second racing game where objects run on an inter-base course.

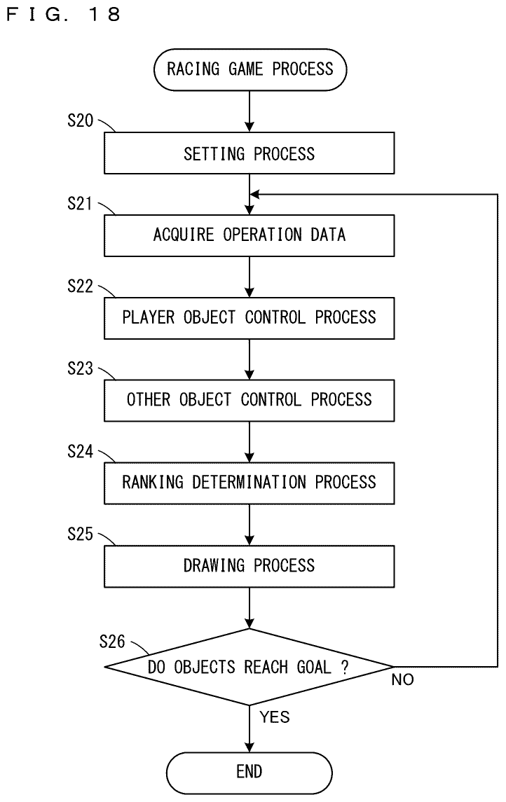

FIG. 17 is a diagram showing examples of various pieces of data used in a racing game process shown in FIG. 18. The various pieces of data shown in FIG. 17 are stored in a memory (e.g., the DRAM 27, the flash memory 26, an external storage medium connected to the slot 29, or the like) of the main body apparatus 2.

As shown in FIG. 17, the memory of the main body apparatus 2 stores a game program, field data, inter-base course data, player object data, other object data, and the determination two-dimensional data.

The game program is a program for executing a racing game process described below. For example, the game program is stored in advance in an external storage medium attached to the slot 29 or the flash memory 26 and is read to the DRAM 27 when the racing game is executed.

The field data is data indicating the entirety of the field F. The field data includes data indicating a plurality of base areas and data indicating a plurality of inter-base routes.

The inter-base course data is data regarding an inter-base course where the second racing game is performed. The inter-base course is a course including an inter-base route connecting a first base area and a second base area.

The player object data is data regarding the player object 31 controlled by the first player of the main body apparatus 2. The player object data includes data indicating the shape of the player object 31, data indicating the position and the orientation of the player object 31, and data indicating the velocity and the acceleration of the player object 31. The player object data also includes data indicating the current degree of progress of the player object 31 and data indicating the current ranking of the player object 31.

The other object data is data regarding a plurality of other progress objects including the progress object 32 operated by the second player and the progress object 33 controlled by the processor 21. Similarly to the player object data, the other object data includes data indicating the positions and the orientations of the progress objects 32 and 33 and data indicating the velocities and the accelerations of the progress objects. The other object data also includes data indicating the current degrees of progress of the other progress objects 32 and 33 and data indicating the current rankings of the other progress objects 32 and 33.

The determination two-dimensional data is the above determination two-dimensional data generated by the generation apparatus. The determination two-dimensional data is stored in the external storage medium connected in advance to the slot 29 or the flash memory 26. The determination two-dimensional data may be acquired from another apparatus via a network (e.g., the Internet).

### Racing Game Process

Next, a description is given of a racing game process performed by the main body apparatus 2. FIG. 18 is a flow chart showing an example of the racing game process. A description is given below of a case where the racing game is performed in the multiplay mode by the main body apparatus 2 corresponding to the first player and another main body apparatus 2 corresponding to the second player communicating with each other. The process shown in FIG. 18 is performed by the processor 21 of the main body apparatus 2 corresponding to the first player executing the game program using the DRAM 27. The process shown in FIG. 18 is started if the first player gives an instruction to perform the second racing game. Although a description is given below of a case where the second racing game using an inter-base course is performed, a similar process is performed also in a case where the first racing game using an intra-base course is performed.

First, the processor 21 performs a setting process (step S20). Here, based on an operation of the player, the processor 21 sets an inter-base course where the second racing game is performed. For example, the processor 21 places the plurality of progress objects including the player object 31 at a starting point of an inter-base course selected by the player. Then, the processor 21 starts the second racing game using the inter-base course.

If the second racing game is started, the processor 21 acquires operation data (step S21). Specifically, the processor 21 acquires the operation data from the controllers 3 and 4. From this point onward, the processor 21 repeatedly executes the processes of steps S21 to S26 at predetermined frame time intervals (e.g., 1/60-second intervals).

Next, the processor 21 executes a player object control process (step S22). Here, based on the operation data, the processor 21 updates information regarding the player object 31. For example, based on the operation data, the processor 21 updates the position, the orientation, the velocity, and the like of the player object 31 and causes the player objects 31 to perform a predetermined action. Here, an item acquisition object is placed in the virtual space. If the player object 31 comes into contact with the item acquisition object, any of a plurality of types of items is given to the player object 31. The given item is used in accordance with an operation input of the player. If the item is used, an effect that differs in accordance with the type of the item is produced. For example, the plurality of types of items include an item for temporarily increasing the velocity of the player object 31, an item for temporarily decreasing the velocity of another progress object, an item for obstructing the running of another progress object, and the like. The plurality of types of items also include an item having a great effect and an item having a small effect. The determination of which type of item is given to the player object 31 is made in accordance with the ranking of the player object 31 when the player object 31 comes into contact with the item acquisition object. If the current ranking of the player object 31 is low, an item having a high advantage for the player object 31 (an item having a great effect) is likely to be given. If the current ranking of the player object 31 is high, an item having a lower advantageous for the player object 31 (an item having a smaller effect) is likely to be given. If the player object 31 acquires an item or uses an item, information regarding the item is transmitted to the other main body apparatus 2 corresponding to the second player.

Next, the processor 21 executes an other object control process (step S23). Here, the processor 21 controls the progress object 32 operated by the second player and the progress object 33 controlled by the processor 21 in the virtual space. For example, based on data transmitted from the other main body apparatus 2 corresponding to the second player, the processor 21 updates the position, the orientation, the velocity, and the like of the progress object 32 and causes the progress object 32 to perform a predetermined action. If the progress object 32 acquires an item or uses an item, the processor 21 performs a process corresponding to the acquisition or the use of the item based on the data transmitted from the other main body apparatus 2. Based on a predetermined algorithm, the processor 21 updates the position, the orientation, the velocity, and the like of the progress object 33 and causes the progress object 33 to perform a predetermined action or use a given item. The processor 21 determines whether or not the progress object 33 comes into contact with the item acquisition object. If the progress object 33 comes into contact with the item acquisition object, the processor 21 gives any of the plurality of types of items to the progress object 33 based on the ranking of the progress object 33.

After step S23, the processor 21 performs a ranking determination process (step S24). Here, based on the determination two-dimensional data, the processor 21 calculates the degrees of progress of the progress objects (31 to 33) in the racing game. For example, based on the determination two-dimensional data and the position of the player object 31, the processor 21 calculates the degree of progress of the player object 31 (a value from “0” to “1”) and stores the degree of progress as the player object data. Based on the determination two-dimensional data and the positions of the progress objects 32 and 33, the processor 21 also calculates the degrees of progress of the progress objects 32 and 33 and stores the degrees of progress as the other object data. Then, based on the calculated degrees of progress of the progress objects, the processor 21 determines the current rankings of the progress objects and stores the current rankings in the memory. It is determined that a progress object having the highest degree of progress ranks first.

Next, the processor 21 performs a drawing process (step S25). Here, the processor 21 generates a game image of the virtual space viewed from the virtual camera corresponding to the player object 31. The game image includes an image of the player object 31 and the ranking display 45 corresponding to the ranking of the player object 31 determined in step S24. The processor 21 outputs the generated game image to a display device.

Next, the processor 21 determines whether or not the objects reach a goal (step S26). Specifically, the processor 21 determines whether or not all the progress objects including the player object 31 and the progress objects 32 and 33 reach a goal point set in the course. If not all the progress objects reach the goal (step S26: NO), the processor 21 executes the process of step S21 again. The processes of steps S21 to S26 are repeatedly performed, whereby the racing game progresses. If the ranking of the player object 31 changes during the racing game, the changed ranking is displayed in the game image.

If all the progress objects reach the goal (step S26: YES), the processor 21 displays the result of the current racing game, and ends the racing game process shown in FIG. 18.

As described above, in the game according to the exemplary embodiment, in a case where a racing game is performed on an inter-base course where progress objects can run in a wide range on a field, the degrees of progress of the progress objects are calculated based on determination two-dimensional data, and the rankings of the progress objects are determined. The determination two-dimensional data has two-dimensional coordinate values corresponding to positions with respect to the horizontal direction in a virtual space, and stores a determination parameter indicating the degree of progress with respect to each coordinate point. Consequently, even on a course where the progress objects can run in a wide range on the field, it is possible to accurately determine the rankings of the progress objects during the racing game.

The current ranking of a progress object influences the type of an item to be given to the progress object. An accurate ranking determination is made, whereby it is possible to give an appropriate item.

### Variations

While the exemplary embodiment has been described above, the exemplary embodiment is merely an example and may be modified as follows, for example.

For example, in the above exemplary embodiment, the generation process for generating the determination two-dimensional data is performed in advance by the computer of the game creator. In another exemplary embodiment, the generation process may be executed by the main body apparatus 2 (a game apparatus that performs the racing game process). For example, in the main body apparatus 2, the player may be able to freely create a course where the racing game is performed. In this case, determination two-dimensional data cannot be generated and stored in advance, but the main body apparatus 2 may perform the above generation process based on the course created by the player, thereby generating determination two-dimensional data corresponding to the course. For example, the main body apparatus 2 may generate determination two-dimensional data at the start of the racing game using the course, or may generate determination two-dimensional data in advance when the racing game is not performed, such as when the course is created. Even in a case where the player cannot create a course where the racing game is performed, based on course data, the main body apparatus 2 may generate determination two-dimensional data corresponding to the course data. For example, based on new course data acquired via the Internet, the main body apparatus 2 may generate determination two-dimensional data corresponding to the course data.

In the above exemplary embodiment, on the premise that the racing game is performed on an inter-base course including an inter-base route connecting a first base area and a second base area, the rankings of the progress objects during the racing game using the inter-base course are determined based on the determination two-dimensional data. In another exemplary embodiment, in a case where the racing game is performed not only on an inter-base course but also on any course set in the virtual space, the rankings of the progress objects during the racing game using the course may be determined based on the determination two-dimensional data.

In the above exemplary embodiment, a course where the progress objects start from a starting point set in a first base area and head for a goal point set in a second base area is set. In another exemplary embodiment, a course where the progress objects pass through a plurality of base areas may be set. In such a course where the progress objects pass through a plurality of base areas, the progress objects may start from a starting point, pass through a first checkpoint set in a first base area, run from the first checkpoint, pass through a second checkpoint set in a second base area, further run from the second checkpoint, and run toward a third checkpoint set in a third base area. During the racing game where the progress objects run from the first checkpoint to the second checkpoint, the rankings of the progress objects may be determined based on the above determination two-dimensional data. In the determination two-dimensional data in this case, “0” is set as the determination parameter of a coordinate point corresponding to the first checkpoint, and “1” is set as the determination parameter of a coordinate point corresponding to the second checkpoint.

In the above exemplary embodiment, “0” is set as the value of the determination parameter for a starting point, “1” is set as the value of the determination parameter for a goal point, and a value between “0” and “1” is set as the value of the determination parameter for a position between the starting point and the goal point. The values of the determination parameters are not limited to this. For example, the value of the determination parameter of the starting point may be greater than the value of the determination parameter of the goal point. The values of the determination parameters at positions may not continuously change so that as the position comes close to the goal point from the starting point, the value becomes greater or smaller. For example, the values of the determination parameters at positions may be encrypted, and discontinuous values may be set as the values of the determination parameters of the positions.

The determination two-dimensional data may include coordinate points in a region where the progress objects can run but is not recommended to run, in addition to coordinate points in an inter-base route R where the progress objects can run and coordinate points in the runnable region 51 where the progress objects can run. For a coordinate point in such a region where the progress objects are not recommended to run, a value (e.g., a negative value or a value exceeding “1”) in a range different from the range where values can be set as coordinate points in the inter-base route R and the runnable region 51 may be set as the value of the determination parameter. If the player object 31 is running on such a region, display indicating that the player object 31 is running on a region where the player object 31 is not recommended to run may be performed instead of (or in addition to) the ranking display 45. The determination two-dimensional data may include coordinate points corresponding to a region where the progress objects cannot run.

In the above exemplary embodiment, a single value of the determination parameter is set for each coordinate point included in the determination two-dimensional data. In another exemplary embodiment, a single value of the determination parameter may be set for a region (a section having a predetermined distance) surrounded by coordinate points. That is, the virtual space may be divided into predetermined regions, and the value of the determination parameter may be set for each region. Then, the value of the determination parameter corresponding to a region where a progress object is located may be calculated as the degree of progress of the progress object.

In the above exemplary embodiment, coordinate points included in the intermediate data are randomly set. In another exemplary embodiment, for example, coordinate points included in the intermediate data may be set at intervals set in advance.

The racing game according to the exemplary embodiment may be a game where the plurality of progress objects including the player object are progressed on a course at least including a route from a first point to a second point on the field. The determination two-dimensional data is two-dimensional data corresponding to two-dimensional coordinate points with respect to the horizontal direction in the virtual space in a predetermined range at least including the route, and is data in which a first value is recorded for a coordinate point corresponding to the first point, a second value is recorded for a coordinate point corresponding to the second point, and a determination parameter indicating the degree of progress from the first point to the second point with a value from the first value to the second value is recorded with respect to each coordinate point. The first point may be a starting point, or may be a first checkpoint. The second point may be a goal point, or may be a second checkpoint.

In the above exemplary embodiment, rankings during the racing game are determined based on the determination two-dimensional data. In another exemplary embodiment, based on the determination two-dimensional data, not only are rankings during the racing game determined, but also another determination may be made, or display corresponding to the other determination may be performed.

For example, the degrees of progress of the progress objects calculated based on the determination two-dimensional data may be displayed.

The degrees of progress of the progress objects calculated based on the determination two-dimensional data may be evaluated, and the results of the evaluations may be displayed. For example, in a case where a racing game where the progress objects aim to reach a particular degree of progress within a predetermined time is performed, it may be determined whether or not the progress objects reach the particular degree of progress within the predetermined time, and display corresponding to the determination may be performed.

In accordance with the degrees of progress of the progress objects calculated based on the determination two-dimensional data, an event may occur. For example, it may be determined whether or not the degree of progress of the player object 31 reaches a particular degree of progress. If the player object 31 reaches the particular degree of progress, an event may occur.

The determination two-dimensional data may be used not only for the above purposes but also for another purpose. For example, the determination two-dimensional data may be used to calculate an efficient route from a starting point (or a first checkpoint) to a goal point (or a second checkpoint). For example, in a case where the progress object 32 closer to the goal point than the player object 31 is present, and if the player object 31 acquires and uses a particular item, the particular item moves toward the progress object 32. The moving path of such a particular item may be calculated based on the determination two-dimensional data. For example, the moving direction of the particular item may be determined based on the value of the determination parameter at a coordinate point in the determination two-dimensional data corresponding to the position in the virtual space where the particular item is currently present. Specifically, in a case where the particular item is located at a first position in the virtual space, among a plurality of coordinate points on the periphery of a first coordinate point in the determination two-dimensional data corresponding to the first position, a second coordinate point having a value greater than the value of the determination parameter of the first coordinate point may be extracted, and a direction from the first coordinate point to the second coordinate point may be determined as the moving direction of the particular item.

For example, in a case where the player moves the player object from a starting point to a destination on a field like a desert where a road visible to the player is not set, a route recommended in advance is internally set from the starting point to the destination. In such a case, the direction in which the player object is moved may be determined based on the determination two-dimensional data, and the determined direction may be displayed in a game image. Consequently, the player can determine in which direction the player object should be progressed.

In the above exemplary embodiment, in the racing game, the plurality of progress objects start from a single starting point and head for a single goal point. In another exemplary embodiment, a racing game where a plurality of starting points are prepared, and the plurality of progress objects start from the plurality of starting points and head for a single goal point may be performed. Also in such a case where a plurality of starting points are present, it is possible to generate determination two-dimensional data by the above generation method. Then, based on the generated determination two-dimensional data, it is possible to calculate the current degrees of progress of the plurality of progress objects and determine the rankings of the plurality of progress objects. In another exemplary embodiment, a racing game where a plurality of goal points are prepared, and the plurality of progress objects start from one or more starting points and head for the plurality of goal points may be performed. For example, the player object 31 may start from a first starting point and head for a first goal point, the progress object 32 may start from the first starting point and head for a second goal point, and the progress object 33 may start from a second starting point and head for a third goal point. Also in a case where such a racing game is performed, it is possible to generate determination two-dimensional data by the above generation method, calculate the current degrees of progress of the plurality of progress objects based on the determination two-dimensional data, and determine the rankings of the plurality of progress objects.

In the above exemplary embodiment, a determination is made based on the determination two-dimensional data. In another exemplary embodiment, a determination may be made based on determination three-dimensional data instead of the above determination two-dimensional data. For example, the plurality of progress objects including the player object progress on a course including a route from a first point to a second point including the height direction in the virtual space. This route is a route extending in the horizontal direction and the vertical direction in a three-dimensional space. The determination three-dimensional data is three-dimensional data corresponding to three-dimensional coordinate points in the virtual space in a predetermined range at least including the route, and is data in which a first value is recorded for a coordinate point corresponding to the first point, a second value is recorded for a coordinate point corresponding to the second point, and a determination parameter indicating the degree of progress from the first point to the second point with a value from the first value to the second value is recorded with respect to each coordinate point. Then, a determination may be made based on the value of the determination parameter at a coordinate point in the determination three-dimensional data corresponding to the three-dimensional position in the virtual space of the player object.

The above processing may be executed not only by the main body apparatus 2, but also by any information processing apparatus such as a smartphone or a tablet terminal. The above processing may be executed by an information processing system including a plurality of apparatuses connected together via a network (e.g., a LAN, the Internet, or the like).

For example, in the above exemplary embodiment, the main body apparatus 2 executes the process shown in FIG. 18, and the computer of the game creator executes the process shown in FIG. 16. In another exemplary embodiment, at least a part of the process shown in FIG. 18 may be performed by a server on the Internet. The process shown in FIG. 16 may be performed by a server on the Internet.

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors of an information processing apparatus to execute game processing comprising:
performing a racing game where a player object is progressed on a course set on a field in a virtual space and at least including a route from a first point to a second point on the field; and
during the racing game,
controlling the player object to move based on an operation input, and
based on determination two-dimensional data which is two-dimensional data corresponding to two-dimensional coordinate points with respect to a horizontal direction in the virtual space in a predetermined range at least including the route and in which a first value is recorded for a coordinate point corresponding to the first point, a second value is recorded for a coordinate point corresponding to the second point, a determination parameter indicating a degree of progress from the first point to the second point with a value from the first value to the second value is recorded with respect to each coordinate point,
making a first determination based on the value of the determination parameter at a coordinate point in the determination two-dimensional data corresponding to a position in the virtual space of the player object.

2. The one or more non-transitory computer-readable media according to claim 1, wherein
the racing game is a racing game where the player object races another progress object, and
the game processing further comprises:
during the racing game,
further controlling the other progress object to move; and
as the first determination, determining a ranking of the player object regarding the degree of progress during the racing game based on the value of the determination parameter at the coordinate point in the determination two-dimensional data corresponding to the position in the virtual space of the player object and the value of the determination parameter at a coordinate point in the determination two-dimensional data corresponding to a position in the virtual space of the other progress object.

3. The one or more non-transitory computer-readable media according to claim 2, wherein
the first point is a starting point of the course, and
the second point is a goal point of the course.

4. The one or more non-transitory computer-readable media according to claim 2, wherein
the first point is a first checkpoint of the course, and
the second point is a second checkpoint set beyond the first checkpoint.

5. The one or more non-transitory computer-readable media according to claim 2, wherein
the game processing further comprises
during the racing game,
in accordance with contact between the player object and an item acquisition object on the field, causing the player object to acquire any of items set based on the ranking among a plurality of types of items.

6. The one or more non-transitory computer-readable media according to claim 1, wherein
the determination two-dimensional data is
data in which a value that changes from the first value to the second value along the route is set as the determination parameter at each of coordinate points corresponding to positions on the route, and
data in which the determination parameter at each of coordinate points corresponding to positions other than the route is set so that the closer to the coordinate point corresponding to the second point the coordinate point is, the closer to the second value the value is.

7. The one or more non-transitory computer-readable media according to claim 1, wherein
the game processing further comprises
generating the determination two-dimensional data based on two-dimensional data in which
the first value is set as the determination parameter at the coordinate point corresponding to the first point, and the second value is set as the determination parameter at the coordinate point corresponding to the second point,
a value that changes from the first value to the second value along the route is set as the determination parameter at each of coordinate points corresponding to positions on the route, and
a value based on the value of the determination parameter of a peripheral coordinate point for which the determination parameter is set is set for a coordinate point for which the determination parameter is not set.

8. One or more non-transitory computer-readable media having stored therein instructions that, when executed, cause one or more processors of an information processing apparatus to execute information processing comprising:
based on a course that is used as a course of a racing game set on a field in a virtual space and at least includes a route from a first point to a second point on the field,
generating determination two-dimensional data which is two-dimensional data corresponding to two-dimensional coordinate points with respect to a horizontal direction in the virtual space in a predetermined range at least including the route and in which as a determination parameter indicating a degree of progress from the first point to the second point is recorded with respect to each coordinate point, based on first two-dimensional data in which
a first value is set as the determination parameter at a coordinate point corresponding to the first point, and a second value is set as the determination parameter at a coordinate point corresponding to the second point,
a value that changes from the first value to the second value along the route is set as the determination parameter at each of coordinate points corresponding to positions on the route, and
a value based on the value of the determination parameter of a peripheral coordinate point for which the determination parameter is set is set for a coordinate point for which the determination parameter is not set.

9. The one or more non-transitory computer-readable media according to claim 8, wherein
the information processing further comprises
generating the determination two-dimensional data so that coordinate points are set at predetermined distances in the virtual space based on the first two-dimensional data.

10. The one or more non-transitory computer-readable media according to claim 8, wherein
the information processing further comprises
generating the determination two-dimensional data by filtering the first two-dimensional data so that the further away from the coordinate point corresponding to the position on the route the coordinate point is, the more strongly filtered the coordinate point is.

11. An information processing method performed by an information processing system, the information processing method comprising:
performing a racing game where a player object is progressed on a course set on a field in a virtual space and at least including a route from a first point to a second point on the field; and
during the racing game,
controlling the player object to move based on an operation input, and
based on determination two-dimensional data which is two-dimensional data corresponding to two-dimensional coordinate points with respect to a horizontal direction in the virtual space in a predetermined range at least including the route and in which a first value is recorded for a coordinate point corresponding to the first point, a second value is recorded for a coordinate point corresponding to the second point, a determination parameter indicating a degree of progress from the first point to the second point with a value from the first value to the second value is recorded with respect to each coordinate point,
making a first determination based on the value of the determination parameter at a coordinate point in the determination two-dimensional data corresponding to a position in the virtual space of the player object.

12. The information processing method according to claim 11, wherein
the racing game is a racing game where the player object races another progress object, and
the information processing method further comprises:
during the racing game,
further controlling the other progress object to move;
as the first determination, determining a ranking of the player object regarding the degree of progress during the racing game based on the value of the determination parameter at the coordinate point in the determination two-dimensional data corresponding to the position in the virtual space of the player object and the value of the determination parameter at a coordinate point in the determination two-dimensional data corresponding to a position in the virtual space of the other progress object.

13. The information processing method according to claim 12, wherein
the first point is a starting point of the course, and
the second point is a goal point of the course.

14. The information processing method according to claim 12, wherein
the first point is a first checkpoint of the course, and
the second point is a second checkpoint set beyond the first checkpoint.

15. The information processing method according to claim 12, further comprising
during the racing game,
in accordance with contact between the player object and an item acquisition object on the field, causing the player object to acquire any of items set based on the ranking among a plurality of types of items.

16. The information processing method according to claim 11, wherein
the determination two-dimensional data is
data in which a value that changes from the first value to the second value along the route is set as the determination parameter at each of coordinate points corresponding to positions on the route, and
data in which the determination parameter at each of coordinate points corresponding to positions other than the route is set so that the closer to the coordinate point corresponding to the second point the coordinate point is, the closer to the second value the value is.

17. The information processing method according to claim 11, further comprising:
generating the determination two-dimensional data based on two-dimensional data in which
the first value is set as the determination parameter at the coordinate point corresponding to the first point, and the second value is set as the determination parameter at the coordinate point corresponding to the second point;
a value that changes from the first value to the second value along the route is set as the determination parameter at each of coordinate points corresponding to positions on the route; and
a value based on the value of the determination parameter of a peripheral coordinate point for which the determination parameter is set is set for a coordinate point for which the determination parameter is not set.

18. An information processing method performed by an information processing system, the information processing method comprising:
based on a course that is used as a course of a racing game set on a field in a virtual space and at least includes a route from a first point to a second point on the field,
generating determination two-dimensional data which is two-dimensional data corresponding to two-dimensional coordinate points with respect to a horizontal direction in the virtual space in a predetermined range at least including the route and in which as a determination parameter indicating a degree of progress from the first point to the second point is recorded with respect to each coordinate point, based on first two-dimensional data in which
a first value is set as the determination parameter at a coordinate point corresponding to the first point, and a second value is set as the determination parameter at a coordinate point corresponding to the second point,
a value that changes from the first value to the second value along the route is set as the determination parameter at each of coordinate points corresponding to positions on the route; and
a value based on the value of the determination parameter of a peripheral coordinate point for which the determination parameter is set is set for a coordinate point for which the determination parameter is not set.

19. The information processing method according to claim 18, further comprising
generating the determination two-dimensional data so that coordinate points are set at predetermined distances in the virtual space based on the first two-dimensional data.

20. The information processing method according to claim 18, further comprising
generating the determination two-dimensional data by filtering the first two-dimensional data so that the further away from the coordinate point corresponding to the position on the route the coordinate point is, the more strongly filtered the coordinate point is.

21. An information processing system comprising:
one or more processors; and
one or more non-transitory computer-readable media having stored therein instructions that, when executed, cause the one or more processors to execute game processing comprising:
performing a racing game where a player object is progressed on a course set on a field in a virtual space and at least including a route from a first point to a second point on the field; and
during the racing game,
controlling the player object to move based on an operation input, and
based on determination two-dimensional data which is two-dimensional data corresponding to two-dimensional coordinate points with respect to a horizontal direction in the virtual space in a predetermined range at least including the route and in which a first value is recorded for a coordinate point corresponding to the first point, a second value is recorded for a coordinate point corresponding to the second point, a determination parameter indicating a degree of progress from the first point to the second point with a value from the first value to the second value is recorded with respect to each coordinate point,
making a first determination based on the value of the determination parameter at a coordinate point in the determination two-dimensional data corresponding to a position in the virtual space of the player object.

22. An information processing system comprising:
one or more processors; and
one or more non-transitory computer-readable media having stored therein instructions that, when executed, cause the one or more processors to execute information processing comprising:
based on a course that is used as a course of a racing game set on a field in a virtual space and at least includes a route from a first point to a second point on the field,
generating determination two-dimensional data which is two-dimensional data corresponding to two-dimensional coordinate points with respect to a horizontal direction in the virtual space in a predetermined range at least including the route and in which as a determination parameter indicating a degree of progress from the first point to the second point is recorded with respect to each coordinate point, based on first two-dimensional data in which
a first value is set as the determination parameter at a coordinate point corresponding to the first point, and a second value is set as the determination parameter at a coordinate point corresponding to the second point,
a value that changes from the first value to the second value along the route is set as the determination parameter at each of coordinate points corresponding to positions on the route; and
a value based on the value of the determination parameter of a peripheral coordinate point for which the determination parameter is set is set for a coordinate point for which the determination parameter is not set.
